(19) United States
(12) Patent Application Publication
(10) Pub. No.: US 2020/0081727 A1
(43) Pub. Date: Mar. 12, 2020

(54) A METHOD AND A SYSTEM FOR HOSTING MULTIPLE MULTI-TENANT APPLICATIONS

(71) Applicant: Anupam AHLUWALIA, Gurgaon (IN)

(72) Inventor: Anupam AHLUWALIA, Gurgaon (IN)

(21) Appl. No.: 16/330,376

(22) PCT Filed: Nov. 30, 2017
(86) PCT No.: PCT/IB2017/057514

§ 371 Date: Mar. 5, 2019

(30) Foreign Application Priority Data
Nov. 30, 2016 (IN) 201611040850

(51) Int. Cl. G06F 9/455; G06F 8/60; H04L 29/08; G06Q 30/02; G06F 16/21; G06F 8/36

(52) U.S. Cl. CPC G06F 9/455; G06F 8/60; G06F 8/36; G06Q 30/0283; G06F 16/211; H04L 67/34

(57) ABSTRACT

The present invention provides a method (200) for hosting multiple multi-tenant applications, the method (200) comprising steps of generating (210) a plurality of applications and combining (220) the plurality of applications to generate an offering. Further, generation of each application, of the plurality of applications, comprises steps of selecting (2102) a plurality of asset types from a group consisting of predefined asset types, generating (2104), at least partially, a plurality of assets of the respective plurality of asset types and/or leveraging, at least partially, the plurality of assets from another application, deploying (2106) the plurality of assets to an instance of a management framework to make the application available on the instance of the management framework and updating (2108) management framework metadata corresponding to the instance of the management framework with a plurality of details pertaining to the application.

### TECHNICAL FIELD

Embodiments of the present invention relate generally to application oriented architectures and more specifically to a method and a system for hosting multiple multi-tenant applications.

### BACKGROUND ART

Software as a Service (SaaS) based applications have recently gained popularity with constant development of cloud computing. A SaaS based application is hosted at a central location, such as a data center, and a plurality of users are allowed to subscribe to the application after payment of a subscription fee. A single instance of the application serves the plurality of users, thus providing a multi-tenant architecture. Further, the SaaS based applications, like many other web based applications, can also be accessed using thin clients such as web-browsers, thus providing services to the plurality of users at a very low initial cost.

However, with the spread of technology, a number of SaaS based applications are being hosted at different locations. A user subscribing to more than one SaaS based application may need to provide large chunks of user related data a number of times for a number of applications. As a result, the user related data is spread across different locations. Apart from causing inconvenience to the user, it causes wastage of storage space due to redundancy in storing of the user related data. Further, if a user wants to move from using one SaaS based application to another SaaS based application, the large chunks of the user related data will have to be transferred over internet from one location to another location. Transfer of the user related data over the internet leads to data security concerns to creep in.

There have been a number of solutions to overcome above mentioned deficiencies, and some of them have been discussed below:

US20110126168A1 provides a cloud based platform for managing SaaS resources. A mediator server connected to computing resources is provided. The mediator server allows developers to develop SaaS based applications using the computing resources. However, SaaS based applications and customer data are stored independent of the computing resources. The platform allows the developers to provide software solutions via the mediator server directly to customers, and ensures data availability and data security.

US20100250712A1 provides an apparatus, a system, a method and a program for providing a multi-tenant SaaS based application that manages and monitors a plurality of other SaaS based applications. An Internet-based interface is provided in a web browser for monitoring and managing use of the plurality of other SaaS based applications. Objects and the state of these objects including all associated attributes related to the plurality of other SaaS based applications are stored in databases associated with the Internet-based interface.

The aforesaid document and other solutions may aim to provide methods and systems for hosting multiple multi-tenant applications, however they suffer from a plurality of limitations. First they do not provide a marketplace of applications, where applications of interest can be subscribed to by the user. Further, the SaaS based applications are not able to correlate with each other, causing redundancy in the methods and systems and wastage of computing resources.

Accordingly, there remains a need in the prior art to have a method and a system for hosting multiple multi-tenant applications which overcome the aforesaid shortcomings.

However, there remains a need in the art for a method and a system for hosting multiple multi-tenant applications which provide a marketplace of SaaS based applications and allow the SaaS based applications to correlate with each other.

### SUMMARY OF THE INVENTION

Embodiments of the present invention aim to provide a method and a system for hosting multiple multi-tenant applications. The method and the system provide a SaaS marketplace and allows the applications to correlate with each other.

According to a first aspect of the present invention, there is provided a method for hosting multiple multi-tenant applications, the method comprising steps of generating a plurality of applications and combining the plurality of applications to generate an offering. Further, generation of each application, of the plurality of applications, comprises steps of selecting a plurality of asset types from a group consisting of predefined asset types, generating, at least partially, a plurality of assets of the respective plurality of asset types and/or leveraging, at least partially, the plurality of assets from another application, deploying the plurality of assets to an instance of a management framework to make the application available on the instance of the management framework and updating management framework metadata corresponding to the instance of the management framework with a plurality of details pertaining to the application.

In accordance with an embodiment of the present invention, the group consisting of predefined asset types comprises event type definitions, master data definitions, reference data definitions, reports, queries, alerts, event metadata fields, event pre-processing rules, event orchestration and workflow tasks.

In accordance with an embodiment of the present invention, the method further comprises a step of associating a base cost to the offering.

In accordance with an embodiment of the present invention, the method further comprises a step of associating a plurality of bundles of technical constraints with the offering, each technical constraint from the plurality of bundles of the technical constraints being one of a plurality of predefined types of technical constraints and bearing a predefined value.

In accordance with an embodiment of the present invention, the method further comprises a step of generating a plurality of service instances corresponding to the plurality of respective applications in the offering.

In accordance with an embodiment of the present invention, the method further comprises a step of recording scheduled processing requirements corresponding to the plurality of applications and the plurality of respective service instances in a schedules repository.

In accordance with an embodiment of the present invention, the method further comprises a step of performing a plurality of checks before generating the plurality of service instances.

In accordance with an embodiment of the present invention, the method further comprises a step of customizing a service instance of the plurality of service instances.

In accordance with an embodiment of the present invention, the step of customizing of the service instance comprises at least one of applying a plurality of restrictions to an asset of the plurality of assets, defining a volume allocation for the asset, appending a plurality of functionalities to the asset and allocating a value to a parameter of a plurality of parameters associated with the asset.

In accordance with an embodiment of the present invention, the step of customizing the service instance comprises a step of making a plurality of protocols available to the service instance.

In accordance with an embodiment of the present invention, the step of customizing the service instance comprises a step of customizing service preferences corresponding to the service instance.

In accordance with an embodiment of the present invention, the method further comprises a step of generating an overall cost for the subscriber, as a function of a plurality of billing parameters.

In accordance with an embodiment of the present invention, the method further comprises a step of performing, during runtime, at least one of processing an event, accessing an asset of the plurality of assets, by a user and accessing a plurality of schedules, by the instance of the management framework.

In accordance with an embodiment of the present invention, the step of processing an event comprises steps of receiving the event using a predefined telecommunication medium and classifying the event in accordance with a second predefined classification, updating event metadata, pertaining to the event, into an event audit table, updating the event to an event store, feeding the event to a plurality of asynchronous stages and orchestrating the event on completion of the plurality of asynchronous stages.

In accordance with an embodiment of the present invention, the second predefined classification comprises field event, query event, sync event and demand event.

In accordance with an embodiment of the present invention, the method further comprises a step of authenticating the predefined telecommunication medium.

In accordance with an embodiment of the present invention, the plurality of asynchronous stages comprise authorization, validation, enrichment and handling.

In accordance with an embodiment of the present invention, the method further comprises a step placing the event in an exception queue on failure of completion of any one of the plurality of asynchronous stages.

In accordance with an embodiment of the present invention, the step of orchestrating the event comprises any one of updating a database schema specific to a corresponding application and generating a communication output.

In accordance with an embodiment of the present invention, the communication output is one of an alert, a workflow task, a notification and an outbound stream.

In accordance with an embodiment of the present invention, the method further comprises steps of assigning one or more roles to a user and restricting access to the plurality of asset types on basis of the one or more roles.

According to a second aspect of the invention, there is provided a method for processing an event, comprising steps of receiving the event using a predefined telecommunication medium and classifying the event in accordance with a second predefined classification, updating event metadata, pertaining to the event, into an event audit table, updating the event to an event store, feeding the event to a plurality of asynchronous stages and orchestrating the event on completion of the plurality of asynchronous stages.

In accordance with an embodiment of the present invention, the second predefined classification comprises field event, query event, sync event and demand event.

In accordance with an embodiment of the present invention, the method further comprises a step of authenticating the predefined telecommunication medium.

In accordance with an embodiment of the present invention, the plurality of asynchronous stages comprise authorization, validation, enrichment and handling.

In accordance with an embodiment of the present invention, the method further comprises a step of placing the event in an exception queue on failure of completion of any one of the plurality of asynchronous stages.

In accordance with an embodiment of the present invention, the step of orchestrating the event comprises any one of updating a database schema specific to a corresponding application and generating a communication output.

In accordance with an embodiment of the present invention, the communication output is one of an alert, a task, a notification and an outbound stream.

According to a third aspect of the present invention, there is provided a system for hosting multiple multi-tenant applications, the system comprising an application module and an offering module. Further, the application module is configured to generate a plurality of applications. Further, for generation of each application, of the plurality of applications, the application module is further configured to select a plurality of asset types from a group consisting of predefined asset types, generate, at least partially, a plurality of assets of the respective plurality of asset types and/or leverage, at least partially, the plurality of assets from another application, deploy the plurality of assets to an instance of a management framework to make the application available on the instance of the management framework and update management framework metadata corresponding to the instance of the management framework with a plurality of details pertaining to the application. Further, the offering module is configured to combine the plurality of applications to generate an offering.

In accordance with an embodiment of the present invention, the group consisting of predefined asset types comprises event type definitions, master data definitions, reference data definitions, reports, queries, alerts, event metadata fields, event pre-processing rules, event orchestration and workflow tasks.

In accordance with an embodiment of the present invention, the offering module further comprises a costing submodule configured to associate a base cost to the offering.

In accordance with an embodiment of the present invention, the offering module further comprises a constraints submodule configured to associate a plurality of bundles of technical constraints to the offering, each technical constraint from the plurality of bundles of the technical constraints being one of a plurality of predefined types of technical constraints and bearing a predefined value.

In accordance with an embodiment of the present invention, the offering module further comprises a generation submodule configured to generate a plurality of service instances corresponding to the plurality of respective applications.

In accordance with an embodiment of the present invention, the system further comprises a schedule management module configured to record scheduled processing requirements corresponding to the plurality of applications and the plurality of respective service instances, in a schedules repository.

In accordance with an embodiment of the present invention, the offering module further comprises a verification submodule configured to perform a plurality of checks before generation of the plurality of service instances.

In accordance with an embodiment of the present invention, the offering module further comprises a customization submodule configured to customize a service instance of the plurality of service instances.

In accordance with an embodiment of the present invention, for customizing the service instance, the customization submodule is further configured to perform at least one of applying a plurality of restrictions to an asset of the plurality of assets, defining a volume allocation for the asset, appending a plurality of functionalities to the asset and allocating a value to a parameter of a plurality of parameters associated with the asset.

In accordance with an embodiment of the present invention, for customizing the service instance, the customization submodule is further configured to make a plurality of protocols available to the service instance.

In accordance with an embodiment of the present invention, for customizing the service instance, the customization submodule is further configured to customize service preferences corresponding to the service instance.

In accordance with an embodiment of the present invention, the offering module further comprises a billing submodule configured to generate an overall cost for the subscriber, as a function of a plurality of billing parameters.

In accordance with an embodiment of the present invention, the system further comprises an event management module configured to receive an event using a predefined telecommunication medium and classifying the event in accordance with a second predefined classification, update event metadata, pertaining to the event, into an event audit table, update the event to an event store, feed the event to a plurality of asynchronous stages and orchestrate the event on completion of the plurality of asynchronous stages.

In accordance with an embodiment of the present invention, the second predefined classification comprises field event, query event, sync event and demand event.

In accordance with an embodiment of the present invention, the event management module is further configured to authenticate the predefined telecommunication medium.

In accordance with an embodiment of the present invention, the plurality of asynchronous stages comprise authorization, validation, enrichment and handling.

In accordance with an embodiment of the present invention, the event management module is further configured to place the event in an exception queue on failure of completion of any one of the plurality of asynchronous stages.

In accordance with an embodiment of the present invention, for orchestrating the event, the event management module is configured to update a database schema specific to a corresponding application and generate a communication output.

In accordance with an embodiment of the present invention, the communication output is one of an alert, a task, a notification and an outbound stream.

In accordance with an embodiment of the present invention, the application module is further configured to assign one or more roles to a user and restrict access to the plurality of asset types on basis of the one or more roles.

According to a fourth aspect of the present invention, there is provided an event management module configured to receive an event using a predefined telecommunication medium and classifying the event in accordance with a second predefined classification, update event metadata, pertaining to the event, into an event audit table, update the event to an event store, feed the event to a plurality of asynchronous stages and orchestrate the event on completion of the plurality of asynchronous stages.

In accordance with an embodiment of the present invention, the second predefined classification comprises field event, query event, sync event and demand event.

In accordance with an embodiment of the present invention, the event management module is further configured to authenticate the predefined telecommunication medium.

In accordance with an embodiment of the present invention, the plurality of asynchronous stages comprise authorization, validation, enrichment and handling.

In accordance with an embodiment of the present invention, the event management module is further configured to place the event in an exception queue on failure of completion of any one of the plurality of asynchronous stages.

In accordance with an embodiment of the present invention, for orchestrating the event, the event management module is further configured to update a database schema specific to a corresponding application and generate a communication output.

In accordance with an embodiment of the present invention, the communication output is one of an alert, a task, a notification and an outbound stream.

### BRIEF DESCRIPTION OF THE ACCOMPANYING DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawing illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein:

FIG. 1 illustrates an exemplary environment to which various embodiment of the present invention may be implemented;

FIG. 2 illustrates a method for hosting multiple multi-tenant applications, in accordance with an embodiment of the present invention;

FIG. 3 illustrates a method for generating an application of the plurality of applications, in accordance with an embodiment of the present invention;

FIG. 4 illustrates a relationship diagram between the plurality of applications and a plurality of assets, in accordance with an exemplary embodiment of the present invention;

FIG. 5 illustrates an offering, in accordance with an exemplary embodiment of the present invention;

FIG. 6 illustrates a method for processing an event, in accordance with an embodiment of the present invention;

FIG. 7 illustrates a system for hosting multiple multi-tenant applications, in accordance with an embodiment of the present invention; and

FIG. 8 illustrates an offering module, in accordance with an embodiment of the present invention.

### DETAILED DESCRIPTION OF THE PREFERRED EMBODIMENTS

While the present invention is described herein by way of example using embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of materials are identified as suitable for various facets of the implementations. These materials are to be treated as exemplary, and are not intended to limit the scope of the invention.

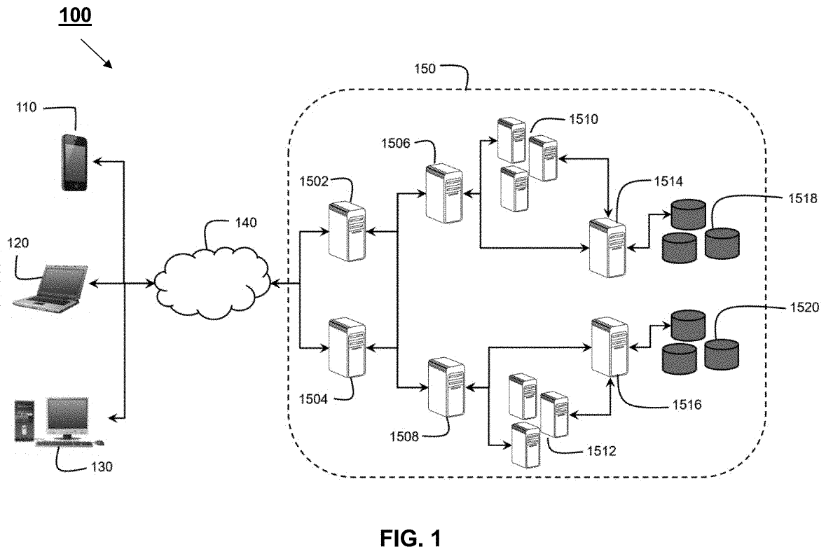

Referring to the drawings, the invention will now be described in more detail. As shown in FIG. 1, an exemplary environment (100) to which various embodiments of the present invention may be implemented. The environment (100) comprises a plurality of client devices (110, 120 and 130) connected to a data center (150) via a network (140). In accordance with various embodiments, the plurality of client devices (110, 120 and 130) are selected from a group consisting of, but are not limited to, mobile handheld devices, personal computers, desktops, laptops, and tablets etc. Further, in accordance with various embodiments, the network (140) is a Local Area Network (LAN) or a Wide Area Network (WAN). Preferably, the network (140) is internet.

In accordance with an embodiment of the present invention, the data center (150) is a cloud based data center. Further the data center (150) comprises a plurality of gateway servers (1502 and 1504). The gateway servers (1502 and 1504) are configured to receive requests in multiple formats such as, but not limited to, HTTP/HTTPS (Hyper Text Transfer Protocol), FTP (File Transfer Protocol) and JMS (Java Message Service) etc. The requests are received via a plurality of telecommunication mediums and protocols from a plurality of browser applications, standalone applications for, but not limited to, messaging or file transfer etc., of the plurality of client devices (110, 120 and 130). Further, the plurality of gateway servers (1502 and 1504) deliver responses in respective formats corresponding to the requests.

The plurality of gateway servers (1502 and 1504) are in turn connected with a plurality of controller servers (1506 and 1508). The plurality of controller servers (1506 and 1508) are configured to manage computing environment in the data center (150) including compute nodes, non-volatile storages, network, virtual machines, images, applications and containers. The plurality of controller servers (1506 and 1508) are connected with a plurality of respective compute node clusters (1510 and 1512) and a plurality of respective storage servers (1514 and 1516). The plurality of compute node clusters (1510 and 1512) are configured to host a number of multi-tenant applications in, but not limited to, virtual machines and containers. The plurality storage servers (1514 and 1516) are configured to provide access to and manage a plurality of respective non-volatile storage clusters (1518 and 1520). Various embodiments of the invention, in the following discussion, may be implemented in the exemplary environment (100) described above, although the invention is not limited to the environment (100) alone.

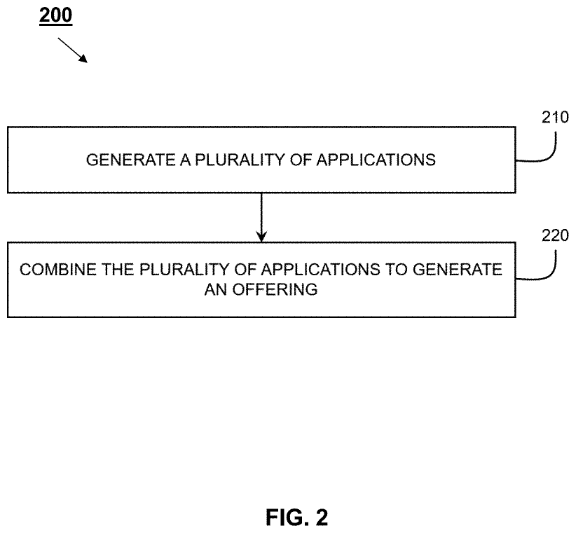

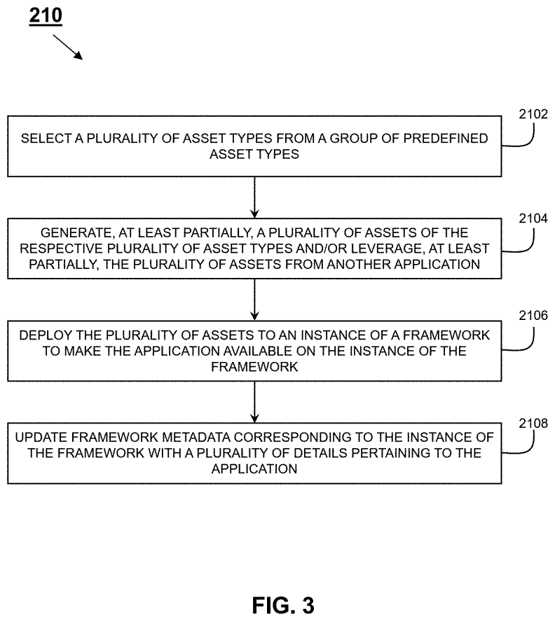

FIG. 2 illustrates a method (200) for hosting multiple multi-tenant applications in accordance with an embodiment of the present invention. The method begins at step 210 by generating a plurality of applications, at the plurality of compute node clusters (1510 and 1512). The plurality of applications are multi-tenant applications. The generation of each application, of the plurality of applications, follows a number of steps. FIG. 3 illustrates a method for generation of an application from the plurality of applications, in accordance with an embodiment of the present invention. At step 2102, a plurality of asset types are selected from a group consisting of predefined asset types, at the plurality of compute node clusters (1510 and 1512). The asset types are predefined in a management framework.

In the context of this specification, the management framework is a basic platform having generic functionalities. The generic functionalities may be overridden while application development and/or deployment. However, global flow of control within the management framework is employed itself by the management framework. In other words, objects and methods custom to the application made available at the framework are instantiated by the management framework. The management framework may comprise a plurality of software libraries, image files, localized strings, header files and reference documentation etc.

The management framework provides common components, user interfaces, customization features with plug in capabilities for the application that complies to the management framework's laid down standards, to be hosted on the management framework. Further the management framework defines methodologies and offers technical capabilities which by design enable hosting of multiple applications which may be subscribed by any or more subscribers. An exemplary management framework may include tools such as, but not limited to, User Interface and Rendering Portal, Enterprise Service Bus, NoSQL Database, Relation Database Management System (RDBMS), Caching Engine, Light Directory Access Protocol (LDAP) server, Java Messaging Service (JMS) provider, Reporting and Charting Libraries, Business Activity Monitoring (BAM) engine and Business Process Management (BPM) or Process Orchestration and Workflow engine.

In accordance with an embodiment, the group consisting of predefined asset types comprises event type definitions, master data definitions, reference data definitions, reports, queries, alerts, event meta-data fields, event pre-processing rules, event orchestration and workflow tasks. The plurality of asset types are predefined within a management framework.

The event type definitions define what type of events will drive one or more processing in the system. In this sense the events are transactional events that form the inputs to an application. Example of an event type is sales order event (i.e. event that is raised when a sales order is placed). The master data definitions define relatively static master data required for the application. Typically master data, although used by the application, is not exclusive to the application and is usually an enterprise asset. An example of master data is a product master (i.e. what products are sold by a subscriber).

The reference data definitions define data which is more dynamic than the master data, i.e. the reference data experiences more changes. The reference data is useful for performing calculations relevant to processing. Usually, the reference data is specific to the application, although not exclusively so. The reference data can be added to deliver additional flexibility in application design choices. An example of the reference data is definition of surcharge defined for each product type or delivery cost based on delivery location etc. Other examples of reference data are distribution cost for various locations in a logistics scenario. Since the distribution costs keep changing due to levies, transportation cost etc. it is neither master data nor transactional data.

The reports define business intelligence delivered in graphical reports as an output, or a mashup. An example of reports is sales revenue by product type. The queries define specific queries that can be served as pre-defined services available to the subscriber.

The alerts are pre-defined and system generated outputs on pre-defined conditions such as breach of some threshold etc. Example of alert type is product sales falling below a threshold in a given period and/or location. The event metadata fields define for each event types, specific fields for which value based restrictions can be set. For example, for sales order event, the event metadata field could be product type, which can then be used to define restrictions on the product type for the order event, i.e. what product types may be accepted in sales order events. These event metadata fields are referred to as event metadata fields per event type. For each, field values can be defined via an automated and readily available method which enables to define authorization restrictions at particular user levels and at company level. This feature is unique as it enables restrictions to be defined for any event without need for new UI development or coding.

The event pre-processing rules define various validations and enrichment of data etc. that must be performed before an event can be accepted for processing. The event orchestration defines orchestration of the event once accepted and the workflow tasks are any tasks that can be initiated by the subscriber.

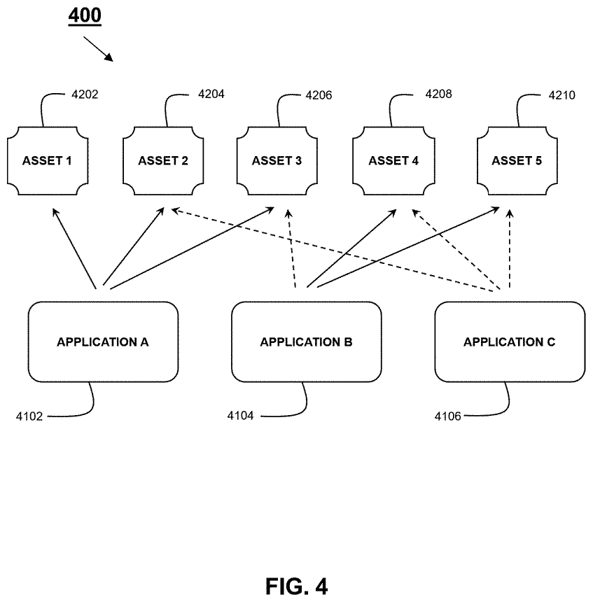

Returning to FIG. 3, at step 2104, a plurality of assets of the plurality of asset types are generated at least partially and/or leveraged, at least partially, from another application of the plurality of applications, at the plurality of compute node clusters (1510 and 1512). This point can be understood from FIG. 4. FIG. 4 illustrates a relationship diagram between the plurality of applications and the plurality of assets, in accordance with an exemplary embodiment (400) of the present invention. As shown in FIG. 4, there are three applications, viz., Application A (4102), Application B (4104) and Application C (4106) and five assets, viz., Asset 1 (4202), Asset 2 (4204), Asset 3 (4206), Asset 4 (4208) and Asset 5 (4210). The solid arrowed lines denote generation and stippled arrowed lines denote leveraging. Asset 1 (4202), Asset 2 (4204), Asset 3 (4206) have been generated for Application A (4102). Asset 4 (4208) and Asset 5 (4210) have been generated for Application B (4104), whereas Asset 3 (4206) has been leveraged for Application B (4104) from Application A (4102). For Application C (4106), no assets have been generated, rather, Asset 2 (4204) has been leveraged from Application A (4102) and Asset 4 (4208) and Asset 5 (4210) have been leveraged from Application B (4104).

Therefore, assets of an existing application can be used by another application (called multi or shared assets), as well as some assets can be defined that only become available when two or more applications are subscribed (called combination assets). Thus the feature of multi and combination assets enables application correlation by design. Example of multi assets are master data which are used by multiple subscribers. Example of combination assets are reports that include correlation between two different data belonging to different applications.

At step 2106, the plurality of assets are deployed to an instance of the management framework to make the application available on the instance of the management framework, at the plurality of compute node clusters (1510 and 1512). At step 2108, management framework metadata, corresponding to the instance of the management framework, is updated with a plurality of details pertaining to the application, at the plurality of compute node clusters (1510 and 1512). This makes the management framework aware of the application becoming available on the management framework. Similarly all other applications of the plurality of application are generated using the step 2102 to 2108.

At step 220, the plurality of applications are combined to generate an offering, at the plurality of compute node clusters (1510 and 1512). Thus the offering can be defined that contains all applications relating to Finance industry or HR department etc. Thus enabling application groupings as offerings defined with target customer choices in mind as a SaaS marketplace feature.

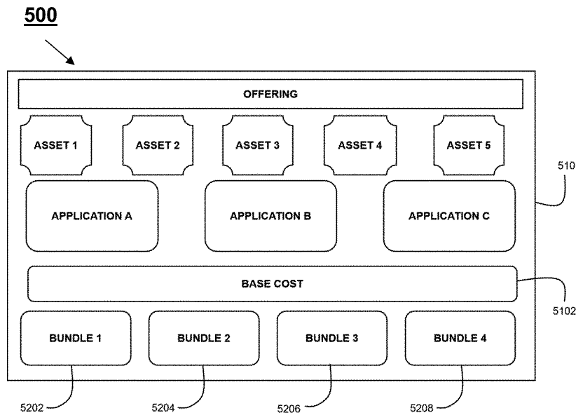

In accordance with an embodiment of the present invention, a base cost is associated with the offering, at the plurality of compute node clusters (1510 and 1512). Further, in accordance with an embodiment, a plurality of bundles of technical constraints associated with the offering, at the plurality of compute node clusters (1510 and 1512). Further, each technical constraint from the plurality of bundles of the technical constraints is one of a plurality of predefined types of technical constraints and bears a predefined value. The technical constraints define to which extent a subscriber can use the processing power and the resources of the datacentre (150). Some of the examples of technical constraints include, but are not limited to, monthly volumes, number of users etc. FIG. 5 illustrates an offering (510), in accordance with an exemplary embodiment (500) of the present invention. As shown, in addition to the applications (4102, 4104 and 4106) and assets (4202, 4204, 4206, 4208 and 4210) as discussed above, the offering (510) comprises a base cost (5102) and a plurality of bundles of technical constraints (5202, 5204, 5206 and 5208). The subscriber selecting the offering (510) will access to all the contents of the offering (510). Once the subscriber selects the offering, the subscriber can make a request for corresponding plurality of service instances to be provided to the subscriber.

In accordance with an embodiment of the present invention, the plurality of service instances, corresponding to the plurality of respective applications in the offering, are generated at the plurality of compute node clusters (1510 and 1512). A service instance is a dedicated instance of a corresponding application generated for a subscriber, where underlying database is segregated, whereas code on which the application runs remain common across a number of subscribers. The plurality of service instances have one to one relation with the plurality of respective applications. For example in FIG. 5, there are three applications Application A (4102), Application B (4104) and Application C (4106), so there will be three service instances provided to the subscriber. This implements a concept of database multi-tenancy while maintaining code single tenancy (although to the subscriber it may appear as code multi tenancy also due to segregation of customization points). Along with multiple applications hosting capability, this feature enables true flexibility by enabling many to many combination for applications to subscriber relationship.

In addition, concept of service instance enables a customer life cycle (like signed up, subscribed, terminated etc.) to be maintained independent of service instance life cycle (like new service, live service, suspended service). This enables flexible version upgrade/downgrade independent of other subscriptions of applications. Also the subscription level billing constraints are permeated through the entire range of applications subscribed using this concept, for example, if total report types that can be subscribed are 10, then it is ensured that the total reports across all of the service instances that are LIVE do not exceed 10. Thus service instance feature provides unique capabilities, including, but not limited to, customization per subscriber on the same host management framework instance, turning off and on application specific subscriptions based on service instance life cycle management and billing controls defined at subscription level to be applied to a wider range of applications (de-centralization).

In accordance with an embodiment of the present invention, a plurality of checks are performed, at the plurality of compute node clusters (1510 and 1512), before the plurality of service instances are generated, for establishing viability of the plurality of service instances. The plurality of checks include, but are not limited to, establishment of legal and commercial arrangements and application integrity checks etc. Further, in accordance with an embodiment, scheduled processing requirements corresponding to the plurality of applications and the plurality of respective service instances are recorded in a schedules repository, from the plurality of compute node clusters (1510 and 1512). The schedules repository is maintained in the plurality of respective non-volatile storage clusters (1518 and 1520).

In accordance with an embodiment of the present invention, a service instance of the plurality of service instances is customized, at the plurality of compute node clusters (1510 and 1512). In accordance with an embodiment, the customizing of the service instance comprises at least one of applying a plurality of restrictions to an asset of the plurality of assets, defining a volume allocation for the asset, appending a plurality of functionalities to the asset and allocating a value to a parameter of a plurality of parameters associated with the asset. Some of the examples in this regard, with respect to different asset types are discussed below.

In case of event type definitions, customization offers some of the following aspects. A plurality of restrictions can be defined on what data can be received for a given event type, where the plurality of restrictions are defined via constraining field values of event metadata fields. For example, the subscriber can define that sales orders can be received for certain product types. In another example, subscriber can further define that sales orders can be received for a user for certain region only. Thereby achieving different region assignment to different users of the subscriber. User restrictions in terms of which user can send or carry out other operations on a particular event type can be defined via allocating users to different event types. Thus enabling a higher level of authorization control on accessibility of event types available to different users. In another example, the event volume allocation can be done based on total volume assigned to the subscriber. For example, if total maximum event volume allocated to subscriber is 10,000 then the total of 10,000 can be distributed amongst all the event types of all the applications that subscriber is subscribed to.

In case of master data, customization is primarily appending functionalities to insert, update, query or delete master data with handles provided for bulk upload of various master data. In case of reference data, customization is very specific to the reference data which by its definition is specific to the application. In some cases, reference data customization may just involve similar functionalities set as master data customization, i.e. insert, update, query and delete or in other cases reference data customization may involve more complex customization functions.

In case of reports, one or more users can be allocated to reports, thus restricting which user can access a given report from authorization stand point. In case there are any constraints defined on number of report types that are available to the subscriber due to the technical constraints, then via customization, the report types of the subscriber's interest can be defined via customization activity. For example, if total number of report types as per the technical constraint are 20, then subscriber can select a total of 20 report types across all of the plurality of applications that he has subscribed to. Customization enables selection and de-selection of these report types.

In case of queries, one or more users can be allocated to the queries, thus restricting which user can access a given query from authorization stand point. In case there are any constraints defined on number of query types that are available to the subscriber due to the technical constraints, then via customization, the query types of subscriber interest can be defined. For example, if total number of query types as per the technical constraint are 20, then the subscriber can select a total of 20 query types across all applications that he has subscribed to. Customization enables selection and de-selection of these query types. Further, the technical constraints also define the query volume, i.e. defining how many times a query can be invoked. Similar to event type's volume constraints, volume allocation to different query types can be performed. In case of rules, values can be defined and maintained for the rules. For example, if a rule defines a threshold value then actual value allocation and changes to the threshold is performed via rules customization. In some cases, the subscriber has a choice to turn off rules, such as validation rules.

In accordance with an embodiment of the present invention, customizing the service instance comprises making a plurality of protocols available to the service instance. This would be true, only if the corresponding application supports the plurality of protocols and the subscriber has activated the use of the plurality of protocols for the application. In accordance with an embodiment of the present invention, customizing the service instance comprises customizing service preferences corresponding to the service instance. Some examples of the service preferences include how particular communication types (notifications in general and specific alert types defined per alert type) are delivered, i.e. selection of communication channel for each alert type. The communication channels that are available for the communication type are a pre-defined list based on which communication protocols are supported by the management framework. Another example would be default language for the service, this depends on which language pack(s) is/are available for the corresponding application.

Thus, a communication type (such as specific alert type) level customization ability is provided to user where he/she can select delivery mechanism based on criticality & relevance to that particular user. There is a hierarchy of preferences supported where communication preferences are defined at subscriber level, then at specific application (that subscriber has subscribed to) level, and then at user level. The lowest level of preference overrides. For example, if user selects communication preference for an alert type ‘Order Event validation failure’ as sms, then regardless of higher level preference, for that particular user the alert will be delivered as sms.

However, it may also be required that access to the plurality of assets be restricted for different users at the subscriber's end. In accordance with an embodiment, one or more roles are assigned to the user at the subscriber end. The one or more roles are assigned at the plurality of compute node clusters (1510 and 1512). The one or more roles are selected from a set of predefined roles. The one or more roles restrict access of the user to the functionality categories such as reports, service instance customization, search or record new events, access queries etc. Further, access to the plurality of asset types is also restricted on basis of the one or more roles, at the plurality of compute node clusters (1510 and 1512). For example incise of record events, the management framework determines first all the applications for which the subscriber (to whom the user belongs) has a valid service instance (a valid service instance is a service instance which is in either LIVE state or SUSPENDED state). Then for that application, all event types that are retrieved based on a telecommunication medium, the user is currently using. For example, if user is using online access, then all event types that belong to online (i.e. Portal based access) are retrieved and offered to the user for selection.

Further, the subscriber may also be billed for the offering. In accordance with an embodiment of the present invention, an overall cost is generated for the subscriber, at the plurality of compute node clusters (1510 and 1512), as a function of a plurality of billing parameters. The plurality of billing parameters comprise, but are not limited to, a volume of events, a volume of queries, a number of report types, a number of query types, usage of the plurality of protocols, respective states of the plurality of applications, respective types of the plurality of applications in the offering, size of deployment (for example processing power allocated) and custom order items such as training and custom development. Further, the base cost associated with the offering is also considered. Thus, a flexible billing control mechanism is provided, which extends beyond simplistic application selection and volumes. The multiple multi-tenant applications may be deployed, once a payment is received from the subscriber. The subscriber can access the multiple multi-tenant applications from the plurality of client devices (110, 120 and 130).

The discussion in the preceding paragraphs has been focused on generation of offerings and providing the offering to the subscriber. However, various embodiments of the method described above make use of certain key entities defined in the management framework and life cycle management of those entities follows certain concepts which are discussed below. The lifecycle stages of an entity may have an inter-relationship with lifecycle stages of other entities and is governed by a rules set. The rules of life cycle inter-relationships provides control mechanism for the management framework to determine access at a commercial, legal & technical level to the management framework and various applications hosted on it. In accordance with an embodiment of the present invention, a plurality of entities are predefined, comprising, customer entity, domain entity, subscription entity, offering entity, bundles entity, technical constraint entity, application entity, service instance entity, a plurality of asset types entities corresponding to the plurality of respective asset types and a billing item entity.

Customer entity is any potential or current subscriber who is desirous or is a user of the system. Domain entity has relationship with the customer entity, each domain can only be associated with a single customer. It is used as a lever to differentiate live usage with respect to demonstration purposes for the same customer. A customer may become a subscriber, once he fulfils certain requirements after which the lifecycle state of customer is changed. Once this change in state for the customer is done, then the customer is enabled to create one or more subscriptions. Thus subscription is a separate entity. While multiple subscriptions may be created, only one subscription can be active for a given customer, which is indicated by a state.

Offerings are defined entities which may be available to associate with subscriptions if offerings are in a state that enables them to be exposed to subscriptions association. Bundles are entities that define technical constraints in form of volumes or accessibility to quantity of assets which are defined by the technical constraint entity. A bundle has one or many technical constraint entities associated with it. Once a bundle is in active state, it is possible to be associated with a subscription, provided bundle has a ‘can-be-associated’ relationship with offering that is selected in the subscription beforehand. In other words, a subscription must select an offering, based on which choices of bundles are made available provided they are in an active state. Technical constraint entity defines pre-defined constraint items, technical constraints are made available to bundles for definition of bundles if they are in an active state.

Application entity is a particular application already deployed on the management framework. An application entity can be associated with an offering if the application is in a state that allows it to be an active application. Service instance is a physical instance of an application. Service instance can be generated and state movement takes place based on state of various other entities such as subscription and vice versa. For example, a subscription can be terminated if all service instances are in terminated state, or a service instance cannot be in LIVE state unless subscription is in Active state etc. Lifecycle state of service instance determines control of delivery of service to subscriber, hence has interplay with other entities at various levels.

The plurality of asset types are entities that are developed and deployed on the management framework. Asset types have a many to many relationship with applications, enabling one application to use many asset types, and one asset type to be used across multiple applications. Asset types are candidates for deployment if they are in an active state. Example of asset type entity is ‘Rule’ or ‘Report’. Billing Item defines an item with commercial implication. Billing items associated with customer entity depending on state, thus enabling billing subsystem to function.

The following discussion now presents runtime performance of the multiple multi-tenant applications. In accordance with an embodiment of the present invention, during runtime, at least one of processing an event, accessing an asset of the plurality of assets, by a user and accessing a plurality of schedules, by the instance of management framework, is performed at the plurality of compute node clusters (1510 and 1512). Further, in accordance with an embodiment, the user accessing the asset includes at least one of initiating a workflow task, recording an event, viewing graphical reports and running a query. Further, the user access the asset from any one or more of the plurality of client devices (110, 120 and 130). The processing of the event can be understood from the following discussion.

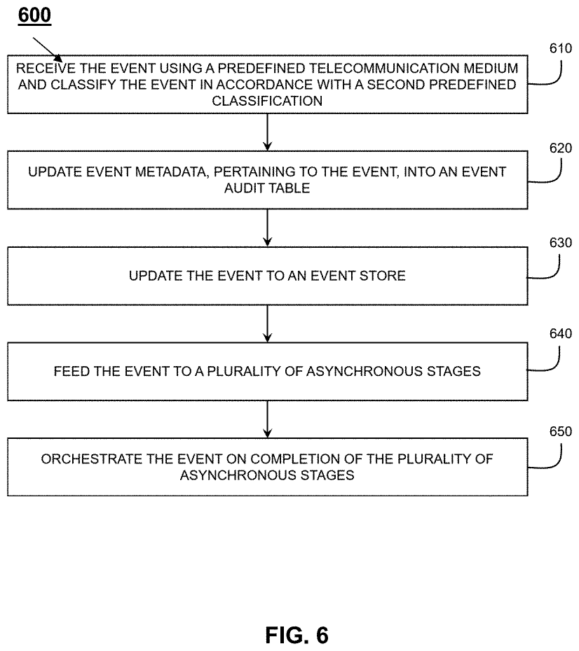

FIG. 6 illustrates a method (600) for processing an event, in accordance with an embodiment of the present invention. The method begins at step 610, by receiving the event using a predefined telecommunication medium and classifying the event in accordance with a second predefined classification. The event is received from any one or more of the plurality of client devices (110, 120 and 130), at the plurality of compute node clusters (1510 and 1512). Further the event is classified at the plurality of compute node clusters (1510 and 1512). The predefined telecommunication medium is one of, but not limited to, an sms, an email and an instant message etc. Further, in accordance with an embodiment, the predefined telecommunication medium is authenticated using an authentication management feature, at the plurality of compute node clusters (1510 and 1512). Further, in accordance with an embodiment, the second predefined classification comprises field event, query event, sync event and demand event.

Field Events are usually events that contain some functional transaction related information that takes place in subscriber's business, for examples a sales order raised. The field events form bulk of the processing design of an application. A hierarchical management feature for accepting field events from users is provided at the plurality of compute node clusters (1510 and 1512). This is a unique feature following hierarchy as follows: Whether user has a role that enables him to send event? Who can send particular event types (the protocol is covered by event type as each event type is linked to a protocol)? What event metadata field restrictions are defined at company level? What event metadata field restrictions are defined at user level?

Query Events are usually API calls for exposed API of an application via pre-defined queries. Hence the query events provide a mechanism for programmatic access to information offered by the application. Sync Events are usually information carriers that are used to synchronize information from other systems in the subscriber's premises with a management framework hosted application master data. Thus the sync events provide a mechanism for subscriber premise systems to act as master and the application hosted on the management framework acts as slave to ensure master data is maintained in sync. Demand events are meant to serve a purpose for fulfilling a subscriber's request that cannot be fulfilled synchronously. This is in contrast to the query events that are serviced in a synchronous manner. Example of demand events is bank statement request, or reconciliation report to be sent via email etc.

At step 620, event metadata pertaining to the event is updated into an event audit table, from the plurality of compute node clusters (1510 and 1512). The event audit table is used to track the journey of the event until the event is accepted for application specific processing. At step 630, the event is updated to an event store. At step 640, the event is fed to a plurality of asynchronous stages. The event store is used to feed the event to the plurality of asynchronous stages. The feeding of the event to the plurality of asynchronous stages may also be called arrangement. The arrangement process is application neutral, which means, the procedure remains constant for events pertaining to all the applications of the plurality of applications. Also, the event audit table and event store are maintained in the plurality of respective non-volatile storage clusters (1518 and 1520)

In accordance with an embodiment of the present invention, the plurality of asynchronous stages comprise authorization, validation, enrichment and handling. Authorization checks are run which are application and event neutral. These checks cannot be turned off. Further, the authorization is based on subscriber specific restrictions and constraints defined as part of customization of the service instance. These are different for different event types and subscribers. Validation checks are run which are event specific and determine whether event is a valid event. The validation rules are event specific, but the rule values (e.g. thresholds) are customizable via customization of the service instance. Besides, additional rules can be implemented which are specific to the subscriber. In many cases, validation rules can be turned off for specific subscribers, or a customized version of same validation rule can be provided for a specific subscriber.

Further, enrichment is event specific which aims to enrich event with additional information as may be required to ensure that the event is brought to common standard with all fields filled with values. The enrichment rules though event specific, follow the same principle as validation, which offers great scope for a subscriber specific behaviour to be implemented. Also, handling is event specific and simply results in selection of application and event specific processing defined as part of event specific orchestration. The handling selection allows to different orchestrations to be selected for different subscribers, thus enabling differences in processing to be accommodated for each subscriber choice.

All of these four asynchronous stages provide plug-ins for application and customer specific rules to be plugged in. Thus enabling standardized code with sufficient flexibility to customize for application and customer needs. In accordance with an embodiment, the event is placed in an exception queue from the plurality of compute node clusters (1510 and 1512), on failure of completion of any one of the plurality of asynchronous stages. Again the exception queue is maintained in the plurality of respective non-volatile storage clusters (1518 and 1520).

At step 650, the event is orchestrated at the plurality of compute node clusters (1510 and 1512), on completion of the plurality of asynchronous stages. In accordance with an embodiment, the orchestration of the event comprises any one of updating a database schema specific to the corresponding application and generating a communication output. The database schema also is maintained in the plurality of respective non-volatile storage clusters (1518 and 1520). The communication output is package as a generic, functionality neutral ‘process backlog message’.

All communication outputs are standardized in management framework and can be produced by any application processing, including arrangement. The standard communication outputs are then processed via a standard processor that ensures standardized processing code used across current and future applications. This is done via providing a standardized metadata for the communication output (header) and actual content of communication (body) segregated. The standard processors use the metadata to process the communication outputs.

In accordance with an embodiment, the communication message is one of an alert, a workflow task, a notification and an outbound stream. The alert is generated when a specific alert type is to be delivered to one or more users. The workflow task is generated when a human workflow task needs to be raised. The notification is a lower severity communication than an alert, to be delivered to a user. The outbound stream allows information to be sent over to the subscriber as an Electronic Data Interchange (EDI) message.

In addition to the embodiments of the method (200) described above, pluggability in the plurality of applications developed over the management framework is also enabled. User interface (UI) pluggability is enabled by developing asset specific UI pages. Example of these are application specific reports and master data etc. Meta data may be defined where asset type when deployed must inform the management framework of the particular UI asset (as a physical asset developed for rendering logic). None or minimal code change is required on the management framework other than deployment of code containing the UI pages. At runtime, the management framework uses the metadata to automatically render the page when that asset type is accessed. For example, when a solution report is clicked on the management framework UI, then the management framework determines the associated UI page and renders it. Thus pluggability for UI provides non-disruptive application deployment on the management framework.

Further, in accordance with an embodiment of the present invention, the management framework allows a built in logic to determine which assets are made available to a user. The logic is based on rule determining assets—user domain issued to determine active subscription, which drives to solution which drives to service instances in a particular state (differs on asset type), this information is collated to deliver the asset types accessible to a logged in user. Thus enabling a non-disruptive application introduction on the management framework. However, this is one level of resolution of assets to be displayed to the user based on which subscriber/domain the user belongs to. Other levels such as role and authorization to the user within a domain are additional levels to determine accessibility of an asset. For example, via customization of a service instance it is possible to allocate reports to only defined users, hence even though by subscription the user should have access to report types of application in enabled state for a LIVE service instance, however restrictions defined by subscriber as part of customization may mean that the user does not see the report types.

Further, in accordance with an embodiment of the present invention, regardless of application deployed, service instance or subscriptions, the access to page area is driven by pre-defined role definition. Thus enabling a non-disruptive access control mechanism on the management framework. Further, in accordance with an embodiment, access controls are defined. Considering an exemplary case of event type definitions as an asset type, the event types can declare control points to the management framework in a non-disruptive manner. For example, an event type for an application must provide fields on which technical constraints can be defined in a form of meta data stored in the management framework tables. This enables a non-disruptive management framework regime, where regardless of event type differences, rich customization features can be offered to any event type of a new solution.

Further, in accordance with an embodiment of the present invention, in case of the arrangement steps as described above, rich pre-processing capabilities are provided that determine whether the input is worthy of undergoing a full processing via orchestration. With different event types, the validation, enrichment rules are expected to be different, just as the event structures are different. The management framework provides a pluggability to auto determine rule selection depending on event type and service instance ID in a non-disruptive way.

Further, in accordance with an embodiment of the present invention, the management framework allows for processing of predefined set of outputs. Any application deployed must produce one of the few pre-defined output types which are then processed by the management framework processors, thus enabling re-use of existing output processing functionality already available in the management framework to any application producing output. Further, in accordance with an embodiment, when the output is produced (for example workflow task, alert, outbound stream etc.) the output is distributed a plurality of users based on group or users set by application in the output (for example, a workflow task output contains distribution information—group “Finance”). The groups are pre-defined in management framework, so applications must distribute to either specified users or to a pre-determined group. However in cases where distribution is more complex, such as a partial number of users from a group etc., then management framework provides flexibility to define rules which will be executed at run time to resolve a set of users who should be given that task. This applies preferably to tasks, but concept is extensible to other output types such as alerts etc.

Further, in accordance with an embodiment, the management framework provides a further customization to deliver differences in user desired behaviour. Customer preferences define account level preferences for items that are applicable at account level. Examples include, but are not limited to language, currency and communication type etc. Here preferences defined are offered as default preferences for all lower hierarchy preferences. For example, communication type ‘Alert’ may have a preference for delivery defined as ‘Email’ but not ‘SMS’. In such case, for all service instances, all type of Alert communication type will be sent as Email unless overridden at service instance level.

Service preferences are defined for specific service instances. Here language, communication types can be over ridden but not currency. Additionally since communication types are detailed for specific communication types available. For example, if Alert was defined as ‘Email’ as a preference for delivery channel, in particular service instance, all Alert types available for the application (to which this service instance has a relationship) are listed with option to change the channel. In terms of user preferences, users can further override the specific preferences propagated from higher levels in the hierarchy in the same manner as service preferences can override customer level preferences.

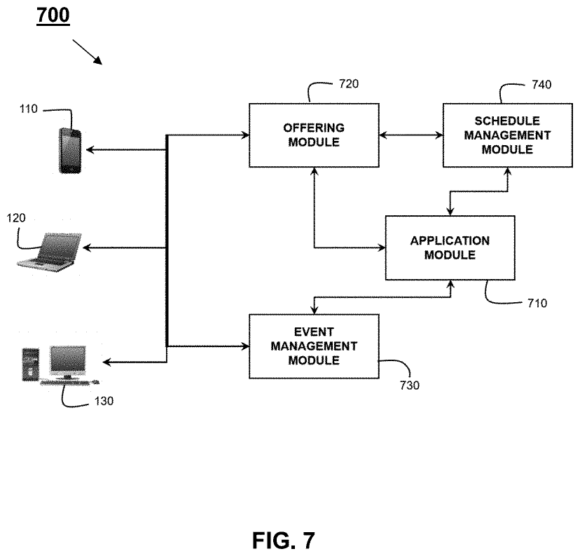

FIG. 7 illustrates a system (700) for hosting multiple multi-tenant applications, in accordance with an embodiment of the present invention. As shown in FIG. 7, the system (700) comprises an application module (710) and an offering module (720). The application module (710) is configured to generate the plurality of applications, at the plurality of compute node clusters (1510 and 1512). Further, for generation of each application, of the plurality of applications, the application module (710) is further configured to select the plurality of asset types from the group consisting of the predefined asset types, at the plurality of compute node clusters (1510 and 1512).

Further, the application module (710) is further configured to generate, at least partially, the plurality of assets of the respective plurality of asset types and/or leverage, at least partially, the plurality of assets from the other application, at the plurality of compute node clusters (1510 and 1512). Further, the application module (710) is further configured to deploy the plurality of assets to the instance of the management framework to make the application available on the instance of the management framework, at the plurality of compute node clusters (1510 and 1512). The application module (710) is also configured to update the management framework metadata corresponding to the instance of the management framework with the plurality of details pertaining to the application, at the plurality of compute node clusters (1510 and 1512). Further, the offering module (720) is configured to combine the plurality of applications to generate the offering, at the plurality of compute node clusters (1510 and 1512).

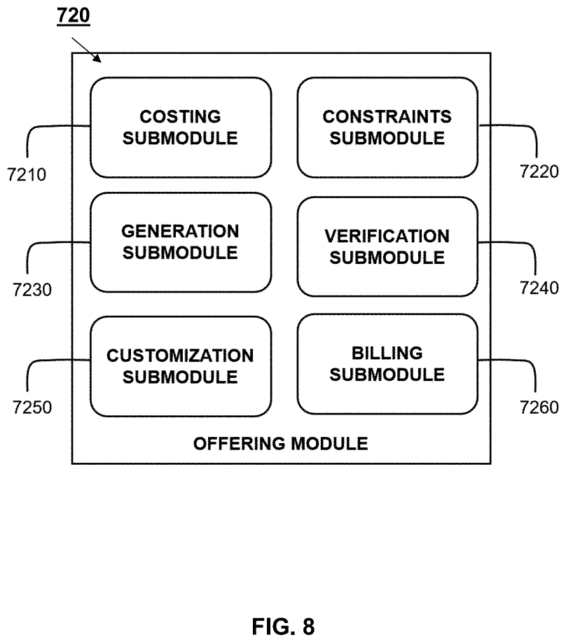

In accordance with an embodiment of the present invention, the application module (710) is further configured to assign the one or more roles to a user and restrict access to the plurality of asset types on the basis of the one or more roles, at the plurality of compute node clusters (1510 and 1512). FIG. 8 illustrates the offering module (720) in accordance with an embodiment of the present invention. As shown in FIG. 8, the offering module (720) further comprises a costing submodule (7210) configured to associate the base cost to the offering, at the plurality of compute node clusters (1510 and 1512). In accordance with an embodiment, the offering module (720) further comprises a constraints submodule (7220) configured to associate the plurality of bundles of technical constraints to the offering, at the plurality of compute node clusters (1510 and 1512).

In accordance with an embodiment of the present invention, the offering module (720) further comprises a generation submodule (7230) configured to generate the plurality of service instances corresponding to the plurality of respective applications, at the plurality of compute node clusters (1510 and 1512). Further, in accordance with an embodiment, the offering module (720) further comprises a verification submodule (7240) configured to perform the plurality of checks before generation of the plurality of service instances, at the plurality of compute node clusters (1510 and 1512). In accordance with an embodiment, the offering module (720) further comprises a customization submodule (7250) configured to customize the service instance of the plurality of service instances, at the plurality of compute node clusters (1510 and 1512).

In accordance with an embodiment of the present invention, for customizing the service instance, the customization submodule (7250) is further configured to perform at least one of applying the plurality of restrictions to the asset of the plurality of assets, defining the volume allocation for the asset, appending the plurality of functionalities to the asset and allocating the value to the parameter of the plurality of parameters associated with the asset. In accordance with an embodiment, for customizing the service instance, the customization submodule (7250) is further configured to make a plurality of protocols available to the service instance. Also, in accordance with an embodiment, for customizing the service instance, the customization submodule (7250) is further configured to customize the service preferences corresponding to the service instance. In accordance with an embodiment, the offering module (720) further comprises a billing submodule (7260) configured to generate the overall cost for the subscriber, as a function of the plurality of billing parameters, at the plurality of compute node clusters (1510 and 1512).

In accordance with an embodiment of the present invention, the system (700) further comprises an event management module (730) configured to receive the event using the predefined telecommunication medium and classify the event in accordance with the second predefined classification, at the plurality of compute node clusters (1510 and 1512). Further, the event management module (730) is further configured to update the event metadata, pertaining to the event, into the event audit table, from the plurality of compute node clusters (1510 and 1512). Further, the event management module (730) is further configured to update the event to the event store, from the plurality of compute node clusters (1510 and 1512). Further, the event management module (730) is further configured to feed the event to the plurality of asynchronous stages, at the plurality of compute node clusters (1510 and 1512). Also, the event management module (730) is further configured to orchestrate the event on completion of the plurality of asynchronous stages, at the plurality of compute node clusters (1510 and 1512).

In accordance with an embodiment of the present invention, the event management module (730) is further configured to authenticate the predefined telecommunication medium, at the plurality of compute node clusters (1510 and 1512). In accordance with an embodiment, the event management module (730) is further configured to place the event in an exception queue on failure of the completion of any one of the plurality of asynchronous stages, from the plurality of compute node clusters (1510 and 1512). In accordance with an embodiment, for orchestrating the event, the event management module (730) is further configured to update the database schema specific to the corresponding application and generate the communication output, from the plurality of compute node clusters (1510 and 1512). In accordance with an embodiment, the system (700) further comprises a schedule management module (740) configured to record the scheduled processing requirements corresponding to the plurality of applications and the plurality of respective service instances in the schedules repository, from the plurality of compute node clusters (1510 and 1512).

The method and a system for hosting multiple multi-tenant applications offer a number of advantages. The invention provides a SaaS marketplace where applications of interest can be flexibly subscribed to by enterprises. Further, the invention provides correlation between offered applications, thus when multiple applications with correlation are selected, the overall value is greater than sum of parts because correlation between applications delivers greater value (in form of additional reports, dashboards etc.). Further, the invention provides a rapid SaaS application development management framework which reduces time to build an application for SaaS by leveraging/reusing parts of management framework and components (such as User Interfaces, Billing engine etc.), common code (such as customization utilities), technologies (such as workflow engine, rules engine etc.). Further, a pre-defined set of entities are provided where strong customization capabilities are offered as a standard. This enables minimal code to be developed for a new application while retaining flexibility required for subscriber specific customization. Also, the invention provides multi tenancy with multiple application support.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claim.

I claim:

1. A method (200) for hosting multiple multi-tenant applications, said method (200) comprising steps of:
generating (210) a plurality of applications; and
combining (220) said plurality of applications to generate an offering;
wherein generation of each application, of said plurality of applications, comprises steps of:
selecting (2102) a plurality of asset types from a group consisting of predefined asset types;
generating (2104), at least partially, a plurality of assets of said respective plurality of asset types and/or leveraging, at least partially, said plurality of assets from another application;
deploying (2106) said plurality of assets to an instance of a management framework to make said application available on said instance of said management framework; and
updating (2108) management framework metadata corresponding to said instance of said management framework with a plurality of details pertaining to said application.

2. The method (200) as claimed in claim 1, wherein said group consisting of predefined asset types comprises event type definitions, master data definitions, reference data definitions, reports, queries, alerts, event metadata fields, event pre-processing rules, event orchestration and workflow tasks.

3. The method (200) as claimed in claim 1, further comprising a step of associating a base cost to said offering.

4. The method (200) as claimed in claim 1, further comprising a step of associating a plurality of bundles of technical constraints with said offering, each technical constraint from said plurality of bundles of said technical constraints being one of a plurality of predefined types of technical constraints and bearing a predefined value.

5. The method (200) as claimed in claim 1, further comprising a step of generating a plurality of service instances corresponding to said plurality of respective applications in said offering.

6. The method (200) as claimed in claim 5, further comprising a step of recording scheduled processing requirements corresponding to said plurality of applications and said plurality of respective service instances, in a schedules repository.

7. The method (200) as claimed in claim 5, further comprising a step of performing a plurality of checks before generating said plurality of service instances.

8. The method (200) as claimed in claim 5, further comprising a step of customizing a service instance of said plurality of service instances.

9. The method (200) as claimed in claim 8, wherein said step of customizing of said service instance comprises at least one of:
applying a plurality of restrictions to an asset of said plurality of assets;
defining a volume allocation for said asset;
appending a plurality of functionalities to said asset; and
allocating a value to a parameter of a plurality of parameters associated with said asset.

10. The method (200) as claimed in claim 8, wherein said step of customizing said service instance comprises a step of making a plurality of protocols available to said service instance.

11. The method (200) as claimed in claim 8, wherein said step of customizing said service instance comprises a step of customizing service preferences corresponding to said service instance.

12. The method (200) as claimed in claim 8, further comprising a step of generating an overall cost for said subscriber, as a function of a plurality of billing parameters.

13. The method (200) as claimed in claim 1, further comprising a step of performing, during runtime, at least one of processing an event, accessing an asset of said plurality of assets, by a user and accessing a plurality of schedules, by said instance of said management framework.

14. The method (200) as claimed in claim 13, wherein said step of processing an event comprises steps of:
receiving (610) said event using a predefined telecommunication medium and classifying said event in accordance with a second predefined classification;
updating (620) event metadata, pertaining to said event, into an event audit table;
updating (630) said event to an event store;
feeding (640) said event to a plurality of asynchronous stages; and
orchestrating (650) said event on completion of said plurality of asynchronous stages.

15. The method (200) as claimed in claim 14, wherein said second predefined classification comprises field event, query event, sync event and demand event.

16. The method (200) as claimed in claim 14, further comprising a step of authenticating said predefined telecommunication medium.

17. The method (200) as claimed in claim 14, wherein said plurality of asynchronous stages comprise authorization, validation, enrichment and handling.

18. The method (200) as claimed in claim 14, further comprising a step of placing said event in an exception queue on failure of completion of any one of said plurality of asynchronous stages.

19. The method (200) as claimed in claim 14, wherein said step of orchestrating said event comprises any one of updating a database schema specific to a corresponding application and generating a communication output.

20. The method (200) as claimed in claim 19, wherein said communication output is one of an alert, a workflow task, a notification and an outbound stream.

21. The method (200) as claimed in claim 1, further comprising steps of:
assigning one or more roles to a user; and
restricting access to said plurality of asset types on basis of said one or more roles.

22. A method (600) for processing an event, comprising steps of:
receiving (610) said event using a predefined telecommunication medium and classifying said event in accordance with a second predefined classification;
updating (620) event metadata, pertaining to said event, into an event audit table;
updating (630) said event to an event store;
feeding (640) said event to a plurality of asynchronous stages; and
orchestrating (650) said event on completion of said plurality of asynchronous stages.

23. The method (600) as claimed in claim 22, wherein said second predefined classification comprises field event, query event, sync event and demand event.

24. The method (600) as claimed in claim 22, further comprising a step of authenticating said predefined telecommunication medium.

25. The method (600) as claimed in claim 22, wherein said plurality of asynchronous stages comprise authorization, validation, enrichment and handling.

26. The method (600) as claimed in claim 22, further comprising a step of placing said event in an exception queue on failure of completion of any one of said plurality of asynchronous stages.

27. The method (600) as claimed in claim 22, wherein said step of orchestrating said event comprises any one of updating a database schema specific to a corresponding application and generating a communication output.

28. The method (600) as claimed in claim 27, wherein said communication output is one of an alert, a task, a notification and an outbound stream.

29. A system (700) for hosting multiple multi-tenant applications, said system (700) comprising:
an application module (710); and
an offering module (720);
wherein said application module (710) is configured to:
generate a plurality of applications, wherein for generation of each application, of said plurality of applications, said application module (710) is further configured to:
select a plurality of asset types from a group consisting of predefined asset types;
generate, at least partially, a plurality of assets of said respective plurality of asset types and/or leverage, at least partially, said plurality of assets from another application;
deploy said plurality of assets to an instance of a management framework to make said application available on said instance of said management framework; and
update management framework metadata corresponding to said instance of said management framework with a plurality of details pertaining to said application;
wherein said offering module (720) is configured to combine said plurality of applications to generate an offering.

30. The system (700) as claimed in claim 29, wherein said group consisting of predefined asset types comprises event type definitions, master data definitions, reference data definitions, reports, queries, alerts, event metadata fields, event pre-processing rules, event orchestration and workflow tasks.

31. The system (700) as claimed in claim 29, wherein said offering module (720) further comprises a costing submodule (7210) configured to associate a base cost to said offering.

32. The system (700) as claimed in claim 29, wherein said offering module (720) further comprises a constraints submodule (7220) configured to associate a plurality of bundles of technical constraints to said offering, each technical constraint from said plurality of bundles of said technical constraints being one of a plurality of predefined types of technical constraints and bearing a predefined value.

33. The system (700) as claimed in claim 29, wherein said offering module (720) further comprises a generation submodule (7230) configured to generate a plurality of service instances corresponding to said plurality of respective applications.

34. The system (700) as claimed in claim 33, further comprising a schedule management module (740) configured to record scheduled processing requirements corresponding to said plurality of applications and said plurality of respective service instances, in a schedules repository.

35. The system (700) as claimed in claim 33, wherein said offering module (720) further comprises a verification submodule (7240) configured to perform a plurality of checks before generation of said plurality of service instances.

36. The system (700) as claimed in claim 33, wherein said offering module (720) further comprises a customization submodule (7250) configured to customize a service instance of said plurality of service instances.

37. The system (700) as claimed in claim 36, wherein for customizing said service instance, said customization submodule (7250) is further configured to perform at least one of:
applying a plurality of restrictions to an asset of said plurality of assets;
defining a volume allocation for said asset;
appending a plurality of functionalities to said asset; and
allocating a value to a parameter of a plurality of parameters associated with said asset.

38. The system (700) as claimed in claim 36, wherein for customizing said service instance, said customization submodule (7250) is further configured to make a plurality of protocols available to said service instance.

39. The system (700) as claimed in claim 36, wherein for customizing said service instance, said customization submodule (7250) is further configured to customize service preferences corresponding to said service instance.

40. The system (700) as claimed in claim 36, wherein said offering module (720) further comprises a billing submodule (7260) configured to generate an overall cost for said subscriber, as a function of a plurality of billing parameters.

41. The system (700) as claimed in claim 29, further comprising an event management module (730) configured to:
receive an event using a predefined telecommunication medium and classifying said event in accordance with a second predefined classification;
update event metadata, pertaining to said event, into an event audit table;
update said event to an event store;
feed said event to a plurality of asynchronous stages; and
orchestrate said event on completion of said plurality of asynchronous stages.

42. The system (700) as claimed in claim 41, wherein said second predefined classification comprises field event, query event, sync event and demand event.

43. The system (700) as claimed in claim 41, wherein said event management module (730) is further configured to authenticate said predefined telecommunication medium.

44. The system (700) as claimed in claim 41, wherein said plurality of asynchronous stages comprise authorization, validation, enrichment and handling.

45. The system (700) as claimed in claim 41, wherein said event management module (730) is further configured to place said event in an exception queue on failure of completion of any one of said plurality of asynchronous stages.

46. The system (700) as claimed in claim 41, wherein for orchestrating said event, said event management module (730) is configured to update a database schema specific to a corresponding application and generate a communication output.

47. The system (700) as claimed in claim 46, wherein said communication output is one of an alert, a task, a notification and an outbound stream.

48. The system (700) as claimed in claim 29, wherein said application module (710) is further configured to:
assign one or more roles to a user; and
restrict access to said plurality of asset types on basis of said one or more roles.

49. An event management module (730) configured to:
receive an event using a predefined telecommunication medium and classifying said event in accordance with a second predefined classification;
update event metadata, pertaining to said event, into an event audit table;
update said event to an event store;
feed said event to a plurality of asynchronous stages; and
orchestrate said event on completion of said plurality of asynchronous stages.

50. The event management module (730) as claimed in claim 49, wherein said second predefined classification comprises field event, query event, sync event and demand event.

51. The event management module (730) as claimed in claim 49, further configured to authenticate said predefined telecommunication medium.

52. The event management module (730) as claimed in claim 49, wherein said plurality of asynchronous stages comprise authorization, validation, enrichment and handling.

53. The event management module (730) as claimed in claim 49, further configured to place said event in an exception queue on failure of completion of any one of said plurality of asynchronous stages.

54. The event management module (730) as claimed in claim 49, wherein for orchestrating said event, said event management module (730) is further configured to update a database schema specific to a corresponding application and generate a communication output.

55. The event management module (730) as claimed in claim 54, wherein said communication output is one of an alert, a task, a notification and an outbound stream.
